(19) United States
(12) Patent Application Publication
(10) Pub. No.: US 2025/0317787 A1
(43) Pub. Date: Oct. 9, 2025

(54) DYNAMIC TRAFFIC BALANCING IN TELECOMMUNICATIONS NETWORKS

(71) Applicant: DISH Wireless L.L.C., Englewood, CO (US)

(72) Inventors: Karupaiah Rajendran, Sachse, TX (US); Ahmed Awwad Whdan, Centennial, CO (US)

(21) Appl. No.: 18/626,843

(22) Filed: Apr. 4, 2024

(51) Int. Cl. H04W 28/02; H04W 28/08; H04W 28/084

(52) U.S. Cl. CPC H04W 28/0263; H04W 28/084; H04W 28/0925

(57) ABSTRACT

Systems and methods of balancing traffic perform or comprise, in a cell site configured to provide network services in a plurality of layers, respective ones of the plurality of layers having different bandwidth characteristics: receiving a traffic data for the cell site; determining a cell radius for respective ones of the plurality of layers; and in response to a determination that the plurality of layers are coincident, distributing a plurality of users to the plurality of layers based on the traffic data.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously-available technologies.

The discussion above is merely provided for general background information and is not intended to be used as an aid in determining the scope of the claimed subject matter.

### SUMMARY

Various aspects of the present disclosure relate to systems and methods in a virtualized telecommunications network to monitor, analyze, and balance traffic in an automated manner.

According to one aspect of the present disclosure, a method of balancing traffic in a telecommunications network is provided. The method comprises, in a cell site configured to provide network services in a plurality of layers, respective ones of the plurality of layers having different bandwidth characteristics: receiving a traffic data for the cell site; determining a cell radius for respective ones of the plurality of layers; and in response to a determination that the plurality of layers are coincident, distributing a plurality of users to the plurality of layers based on the traffic data.

According to another aspect of the present disclosure, a telecommunications network is provided. The telecommunications network comprises a wireless access point configured to provide network services in a plurality of layers, respective ones of the plurality of layers having different bandwidth characteristics; and a virtual radio access network (RAN) server operatively connected to the wireless access point, the virtual RAN server configured to: receive a traffic data for the wireless access point, determine a cell radius for respective ones of the plurality of layers, and in response to a determination that the plurality of layers are coincident, distribute a plurality of users to the plurality of layers based on the traffic data.

According to another aspect of the present disclosure, a non-transitory computer-readable medium is provided. The non-transitory computer-readable medium stores instructions that, when executed by at least one processor of a computer in a telecommunications network configured to provide network services in a plurality of layers respectively having different bandwidth characteristics, cause the computer to perform operations comprising: receiving a traffic data for a cell site of the telecommunications network; determining a cell radius for respective ones of the plurality of layers; and in response to a determination that the plurality of layers are coincident, distributing a plurality of users to the plurality of layers based on the traffic data.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a 5G radio access network architecture in accordance with various aspects of the present disclosure.

FIG. 4 illustrates an example of a telecommunications network sector in accordance with various aspects of the present disclosure.

FIG. 5 illustrates an example of a traffic management method in accordance with various aspects of the present disclosure.

FIG. 6 illustrates an example of a traffic management system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

In an O-RAN model, a single cell site may provide service using a plurality of layers that may have the same coverage footprint in a dense area. For example, a single RU may provide service in a particular coverage area using three different layers having different bandwidth characteristics (e.g., a wide bandwidth layer, a mid bandwidth layer, and a low bandwidth layer). The network may allocate users across the different layers. However, misallocation of users across the layers (e.g., across different frequency bands) may result in inefficient spectrum utilization. To address this, the cell site may be monitored. However, manual tracking systems and methods may result in delays, degraded user experience, reduced throughput, and/or lower spectrum efficiency. Therefore, there exists a need for systems and methods of dynamically balancing traffic in such multi-layer implementations.

The present disclosure describes automated systems and methods of traffic balancing in a network, such as a 5G standalone telecommunications network. In an O-RAN architecture, the automated systems and methods described herein may leverage a RAN Intelligence Controller (RIC) to balance traffic between cells or layers, with decisions based on network data (e.g., users' data payload), thereby to enhance network efficiency. In some implementations, the present disclosure implements a dynamic spectrum allocation system utilizing artificial intelligence (AI)-driven algorithms and RICs. This system may continuously analyze traffic demands and user payloads, and may autonomously modify the allocation of users across frequency bands, ensuring efficient spectrum utilization.

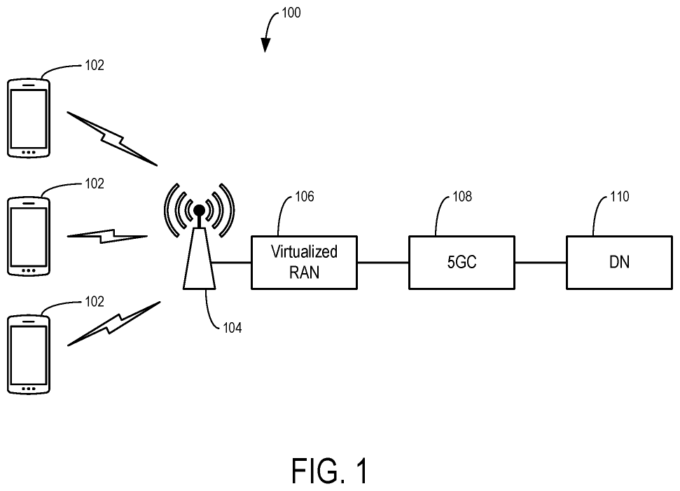

FIG. 1 illustrates an example of a telecommunications network 100 in accordance with various aspects of the present disclosure. In the telecommunications network 100 of FIG. 1, a plurality of user equipment (UEs) 102 are connected to a wireless access point 104, which in turn is connected to a set of virtualized radio access network (RAN) components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (Aps), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

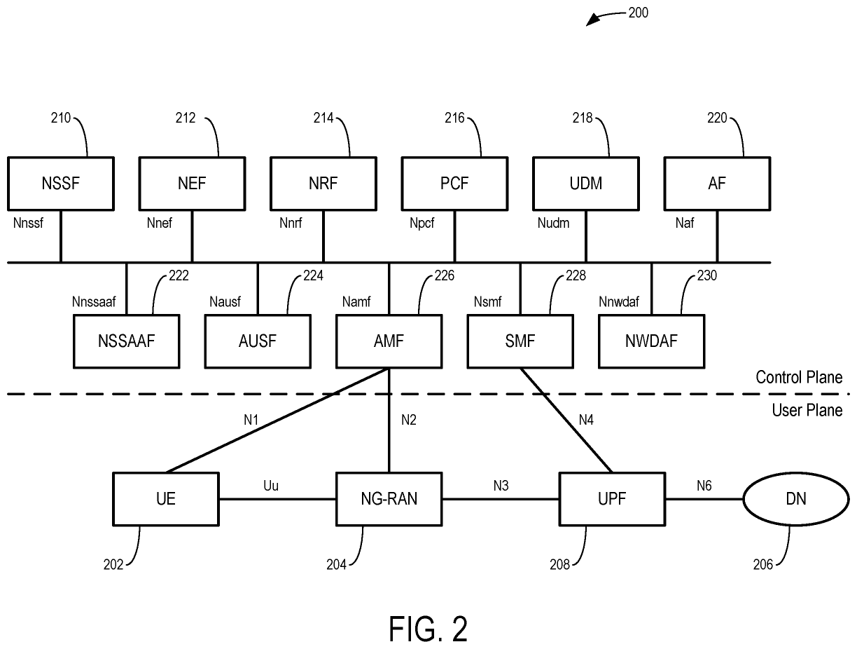

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1). For ease of illustration, FIG. 1 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QOS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation reqUEsts, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The NWDAF 230 is a CP function that collects data from pertinent network infrastructure relevant to a customer's services, including user equipment (device), network functions, network operations and administration, cloud, and edge that can be used for data analytics and insights. It is a unique standalone 5G network function that exposes full visibility to network performance and operations as they relate to a customer's key performance indicators (KPIs).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the telecommunications network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

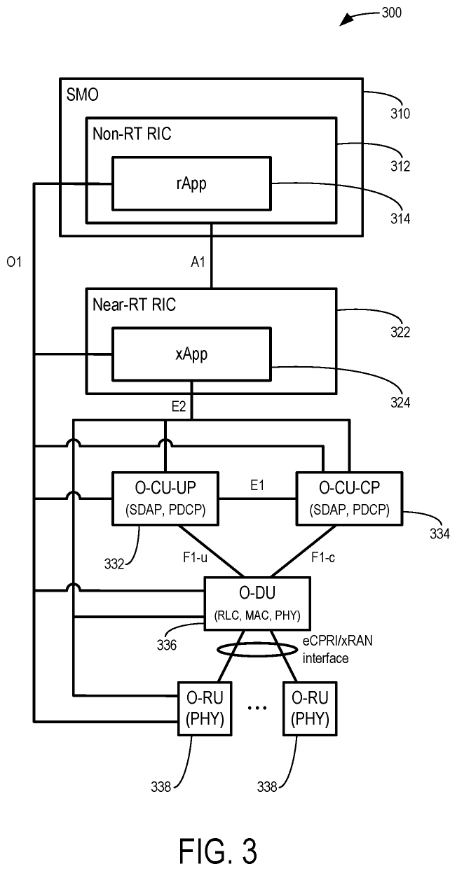

FIG. 3 illustrates an example architecture 300 in an O-RAN network according to various aspects of the present disclosure. The architecture 300 may be, for example, a gNB included in the NG-RAN 204 illustrated in FIG. 2. The architecture 300 may be hosted on customized hardware, on the cloud, or on combinations thereof. The architecture 300 implements several O-Ran NFs, including a Service Management and Orchestration (SMO) function 310 that implements a Non-Real-Time RIC (Non-RT RIC) 312), a Near-Real-Time RIC (Near-RT RIC) 322, an O-RAN CU that includes a User Plane (O-CU-UP) 332 and a Control Plane (O-CU-CP) 334, an O-RAN DU (O-DU) 336, and one or more O-RAN RUs (O-RUs) 338. While FIG. 3 expressly illustrates one O-CU providing service via a single O-DU 336 and two O-RUs 338, in practical implementations any number of O-CUs may be provided and each O-CU may provide service via any number of O-DUs 336 and/or O-RUs 338.

The Non-RT RIC 312 is configured to implement one or more Non-RT RIC Applications (rApp) 314. The Near-RT RIC 322 is configured to implement one or more Near-RT RIC Applications (xApp) 324. The SMO 310 and the Near-RT RIC 332 are connected to one another via an A1 interface. The rApp is connected to the xApp 324, the O-CU-UP 332, the O-CU-CP 334, the O-DU 336, and the O-RUs 338 via an O1 interface. The xApp 324 is connected to the O-CU-UP 332, the O-CU-CP 334, and the O-RUs 338 via an E2 interface. The O-CU-UP 332 and the O-CU-CP 334 are connected to one another via an E1 interface. The O-DU 336 is connected to the O-CU-UP 332 and the O-CU-CP 334 via an F1-U interface and an F1-C interface (e.g., midhaul links), respectively. The O-RUs 338 are connected to the O-DU 336 via a evolved Common Public Radio Interface (eCPRI) connection and/or an xRAN interface (i.e., fronthaul links). The interfaces shown in FIG. 3 may be implemented as IP interfaces (i.e., having end-points denoted by IP addresses).

The 5G radio protocol stack is divided among the O-CU, the O-DU 336, and the O-RU 338. As illustrated, the O-CU-UP 332 and the O-CU-CP 334 include the Service Data Adaptation Protocol (SDAP) and the Packet Data Convergence Protocol (PDCP); the O-DU 336 includes the Radio Link Control (RLC) protocol, the Medium Access Control (MAC) protocol, and the Physical Layer (PHY) protocol; and the O-RU 338 includes the PHY protocol. Data passes through the protocol stack along a path that depends on the data type. Control data (e.g., signaling messages, etc.) pass through the control plane including the O-CU-CP 334, whereas user data passes through the user plane including the O-CU-UP 332.

The SMO 310 is a function that is responsible for RAN domain management. The SMO 310 includes capabilities that provide RAN support, such as the Non-RT RIC 312, cloud management, orchestration, workflow management, and a Fault, Configuration, Accounting, Performance, and Security (FCAPS) interface to other O-RAN NFs.

The Non-RT RIC 312 is a function internal to the SMO 310. It supports intelligent RAN control by providing policy-based guidance, AI (e.g., a machine learning (ML)) model management, and enrichment information to the near-RT RIC 322. As used herein, “non-real-time” refers to control loops with intervals of greater than 1 s. The rApp 314 is a modular application that leverages the functionality exposed by the framework of the Non-RT RIC 312 to perform RAN management and other functions. The rApp 314 may obtain information and trigger actions (e.g., policies, reconfiguration, etc.) for other components of the architecture 300.

The Near-RT RIC 322 is a function that enables near real-time control and management of services and resources of other nodes (e.g., the O-CU, the O-DU 336, and/or the O-RU 338) via fine-grained data collection and actions. Each of these other nodes may be connected to only a single Near-RT RIC 322, although a single Near-RT RIC 322 may be connected to multiple instances of the other nodes. The Near-RT RIC 322 control over the other nodes is steered via the policies and/or the data provided from the Non-RT RIC 312 via the A1 interface. As used herein, “near real-time” refers to control loops with intervals on the order of 10 ms to 1 s. The xApp 324 collects near real-time information (e.g., on a UE basis or a cell basis) and provides additional services.

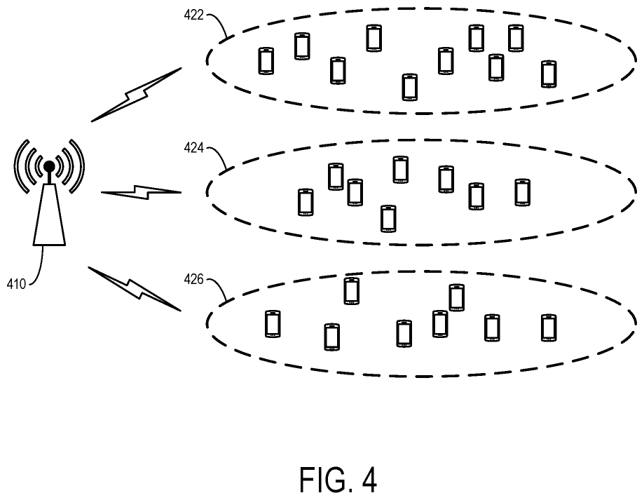

The architecture 300 may be used to provide network services within a coverage zone. The coverage zone may include multiple coverage areas corresponding to different cells or layers. Individual cells or layers may have different spectrum configuration characteristics. FIG. 4 illustrates one example with three cells or layers (referred to in this section simply as “layers” for ease of explanation) per sector, with three different spectrum configurations. FIG. 4 illustrates a cell site 410 providing coverage in a first layer 422, a second layer 424, and a third layer 426. While FIG. 4 illustrates the cell site 410 as a single tower (e.g., a single O-RU 338), in practical implementations the layers 422-426 may be implemented by two or three towers (e.g., two or three different O-RUs 338), which may in turn correspond to the same or different O-DUs 336. For purposes of illustration and explanation, the first layer 422 is a wide bandwidth layer (e.g., having a wider bandwidth than the second layer 424 and the third layer 426), the second layer 424 is a mid bandwidth layer (e.g., having a bandwidth between that of the first layer 422 and the third layer 426), and the third layer 426 is a low bandwidth layer (e.g., having a narrower bandwidth than the first layer 422 and the second layer 424). In one example, the first layer 422 may be in the n71 band, the second layer 424 may be in the n70 band, and the third layer 426 may be in the n66 band.

Each of the layers 422-426 provides service to a plurality of UEs, although at any given time no UEs or one UE may be connected to any individual layer 422-426. An individual UE may connect to a particular layer 422-426 based on frequency priority (e.g., with certain bands being allocated a higher priority based on load, type of service, number of concurrent users, etc.). The network may provide improved service by determining how to allocate each new UE joining the network. Thus, the present disclosure provides systems and methods to dynamically analyze channel and/or carrier usage and allocate UEs (either newly-connecting UEs or one or more already-connected UEs).

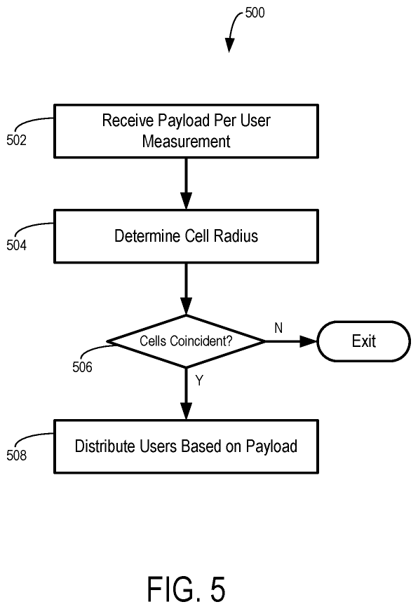

FIG. 5 illustrates an example method 500 for traffic balancing. The method 500 may be performed in a telecommunications network that includes a cell site configured to provide network services in a plurality of layers (e.g., the cell site 410 of FIG. 4). In the example of method 500, the traffic balancing is performed based on user payload. In this example, the method 500 may use an RIC (e.g., the Non-RT RIC 312 and/or the Near-RT RIC 322) as well as instantaneous traffic data to move traffic within a DU (e.g., the O-DU 336) and/or across Dus. The method 500 may be supplemented with additional user data; for example, the RIC may analyze handover statistics and further prioritize UEs based on whether the UE is mobile or stationary. For purposes of explanation, the method 500 will be described as being performed by (or under the control of) the xApp 324, either alone or in coordination with the rApp 314.

The method 500 begins with an operation 502 of receiving a traffic data, such as a payload per user (PPU) measurement. The PPU measurement may be, for example, a downlink (DL) 5G Radio Link Control (RLC) Payload per user (e.g., in Bytes). The xApp 324 may receive the PPU measurement from one or more of the O-CU, the O-DU 336, or the O-RU 338, via the E2 interface. This data may include pre-defined counters and measurements that will be processed by the xApp 324 and/or the rApp 314. Operation 502 may include analyzing the PPU measurement data. For example, the xApp 324 may analyze the DL 5G RLC payload per user during a measurement period. This analysis may assist in understanding the nature and size of the data each UE is transmitting or receiving.

At operation 504, the method 500 determines the cell radius for each of the layers 422-426. In one example, the xApp 324 includes an algorithm that calculates the cell coverage footprint (e.g., a size of the coverage area) based on timing advance information. This data determines the distribution of UEs among the cell and the coverage overlap between the different cells/layers. Based on this information, at operation 506, the method 500 determines whether certain cells/layers are coincident. If multiple cells (e.g., multiple ones of the layers 422-426) are coincident (e.g., include a common coverage area with the same coverage footprint and total overlap), the algorithm of the xApp 324 may be activated. Cell coincidence may indicate that multiple cells are serving the same geographic area. If the cells are determined to be non-coincident at operation 506, the method 500 may terminate or may return to operation 502 for a successive iteration (e.g., after a predetermined delay such as 10-15 minutes). In some implementations, operation 506 may consider cells coincident if they are nested such that one is entirely subsumed within the other (e.g., if the first layer 422 is entirely within the second layer 424, which in turn is entirely within the third layer 426), or if they otherwise include a common coverage area in which all layers provide service.

If the cells are determined to be coincident at operation 506, the method 500 moves to operation 508 and dynamically distributes UEs to specific cells based on payload. The distribution of operation 508 may be group-based. In such implementations, operation 508 may include establishing a plurality of different categories (e.g., based on payload traffic thresholds) and assigning the UEs to the categories based on a comparison of traffic data (e.g., the PPU data received at operation 502) to thresholds. For example, the xApp 324 may assign subsets of the UEs to the different categories based on payload traffic (e.g., a first category for PPU of 100-1000 kB, a second category for PPU of 10-100 KB, and a third category for PPU of 0-10 KB), and then steer or assign the different subsets to different cells (e.g., steering the first category to the first layer 422, the second category to the second layer 424, and the third category to the third layer 426). Thus, for light data sessions like a ping test or SMS communication, UEs may be directed to cells with lower bandwidth, while heavy data users may be directed to cells with higher spectrum resources. The allocations may be permanent or only for a set period of time.

In performing operation 508, the algorithm may retrieve policies from the Non-RT RIC 312 via the A1 interface to guide its decision making processes. Thus, the Non-RT RIC 312 may use one or more rApps 314 to analyze the collected data, to generate policies to steer the UEs based on payload, and/or to set the thresholds based on the policies. These policies may include guidelines for improving user experience and spectrum utilization. The rApp 314 may continuously review policies, spectrum utilization, and/or network congestion to enhance the user experience and spectrum utilization over time. The algorithm itself may operate in near real-time through the Near-RT RIC 322 (e.g., via the xApp 324), thereby ensuring that UE allocations are made promptly and efficiently. After operation 508, the method 500 may terminate or may return to operation 502 for a successive iteration (e.g., after a predetermined delay such as 10-15 minutes).

The operations of method 500 need not be performed one after another in the sequence illustrated in FIG. 5. For example, in some implementations the order of operations 502 and 504 may be transposed, or the operations 502 and 504 may be performed in parallel. Moreover, as noted above, the operations of method 500 may be performed repeatedly at a predetermined interval (e.g., every 10-15 minutes). The predetermined interval may be set by a network operator.

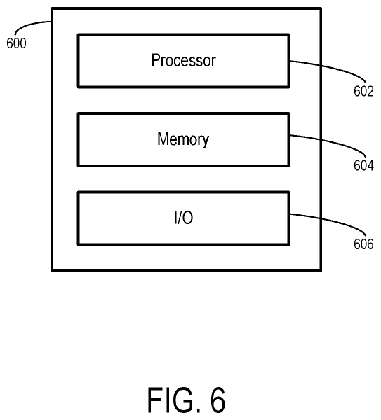

The method 500 may be implemented by a device operating in a telecommunications network. For example, in a telecommunications network including a wireless access point (e.g., wireless access point 104 of FIG. 1) configured to communicate with a UE (e.g., UE 102 of FIG. 1), the method 400 may be implemented on a virtual RAN server (e.g., virtualized RAN components 106 of FIG. 1) that is operatively connected to the wireless access point. FIG. 6 illustrates one example of a virtual RAN server 600.

As illustrated, the virtual RAN server 600 comprises a processor 602, a memory 604, and an input/output (I/O) interface 606. The virtual RAN server 600 may be configured with various modules (e.g., various software modules) to implement network management functions, such as traffic management and balancing functions. In one example, the modules may be present in the memory 604 in the form of instructions that, when executed by the processor 602, cause the virtual RAN server 600 to perform any one or more of the operations described herein. In another example, the processor 602 may be configured to load and/or execute instructions from another non-transitory computer-readable medium (e.g., cloud storage or from the memory of another device). In some examples, the following modules may be in the form of xApps and/or rApps (or portions or combinations thereof).

The virtual RAN server 600 may comprise a traffic data module to receive traffic data for a cell site. The traffic data may be a PPU measurement, such as a DL 5G RLC Payload per user. The traffic data module may receive the PPU measurement from one or more of the O-CU, the O-DU 336, or the O-RU 338, via the E2 interface. This data may include pre-defined counters and measurements that will be processed by the xApp 324 and/or the rApp 314. The traffic data module may further be configured to analyze the PPU measurement data, for example during a measurement period. Thus, the traffic data module may assist in understanding the nature and size of the data each UE is transmitting or receiving.

The virtual RAN server 600 may comprise a logic module, such as a determination module to determine a cell radius for respective ones of the plurality of layers. The logic module may be, may include, or may be configured to invoke an algorithm that calculates the cell coverage footprint (e.g., a size of the coverage area) based on timing advance information. This data determines the distribution of UEs among the cell and the coverage overlap between the different cells/layers. Based on this information, the logic module determines whether certain cells/layers are coincident. If multiple cells (e.g., multiple ones of the layers 422-426) are coincident (e.g., include a common coverage area with the same coverage footprint and total overlap), the algorithm may be activated. Cell coincidence may indicate that multiple cells are serving the same geographic area. In some implementations, the logic module may consider cells coincident if they are nested such that one is entirely subsumed within the other (e.g., if the first layer 422 is entirely within the second layer 424, which in turn is entirely within the third layer 426), or if they otherwise include a common coverage area in which all layers provide service.

The virtual RAN sever 600 may comprise a distribution module to dynamically distribute a plurality of users to the plurality of layers based on the traffic data. The distribution may be group-based. In such implementations, the distribution module or another module may establish a plurality of different categories (e.g., based on payload traffic thresholds), and the distribution module may assign the UEs to the categories based on a comparison of traffic data (e.g., the PPU data received by the traffic data module) to thresholds. For example, the distribution module may assign subsets of the Ues to the different categories based on payload traffic (e.g., a first category for PPU of 100-1000 kB, a second category for PPU of 10-100 kB, and a third category for PPU of 0-10 kB), and then steer or assign different the different subsets to different cells (e.g., steering the first category to the first layer 422, the second category to the second layer 424, and the third category to the third layer 426). Thus, for light data sessions like a ping test or SMS communication, Ues may be directed to cells with lower bandwidth, while heavy data users may be directed to cells with higher spectrum resources. The allocations may be permanent or only for a set period of time.

The I/O 606 may include interface components to permit the communication of data to and from external devices or sources. For example, the I/O 606 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O 606 may additionally or alternatively include communication ports and/or interfaces to permit communication with a user. For example, the I/O 606 may include interfaces for a mouse, a keyboard, a display, a graphical user interface (GUI), buttons, switches, etc. Thus, the I/O 606 may permit a user to initiate the operations described herein and subsequently cause them to be performed on an automated basis and/or may be configured to receive instructions for the automated execution of the operations described herein (e.g., at predetermined intervals).

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of balancing traffic in a telecommunications network, the method comprising, in a cell site configured to provide network services in a plurality of layers, respective ones of the plurality of layers having different bandwidth characteristics:
receiving a traffic data for the cell site;
determining a cell radius for respective ones of the plurality of layers; and
in response to a determination that the plurality of layers are coincident, distributing a plurality of users to the plurality of layers based on the traffic data.

2. The method of claim 1, wherein the traffic data includes a payload-per-user data.

3. The method of claim 1, wherein the operation of distributing the plurality of users to the plurality of layers includes:
establishing a plurality of categories based on payload traffic thresholds;
assigning the plurality of users to the plurality of categories based on a comparison of the traffic data to the payload traffic thresholds; and
assigning subsets of the plurality of users in each of the plurality of categories to corresponding ones of the plurality of layers.

4. The method of claim 3, wherein the operation of establishing the plurality of categories includes:
generating at least one policy based on the traffic data; and
setting the payload traffic thresholds based on the at least one policy.

5. The method of claim 1, wherein at least one of the operation of receiving the traffic data, the operation of determining the cell radius, or the operation of distributing the plurality of users to the plurality of layers is performed by a Radio Access Network Intelligence Controller (RIC).

6. The method of claim 5, wherein the RIC includes a Near Real-Time RIC and a Non-Real-Time RIC, and wherein the at least one of the operation of receiving the traffic data, the operation of determining the cell radius, or the operation of distributing the plurality of users to the plurality of layers is performed by the Near Real-Time RIC.

7. The method of claim 1, wherein the operation of determining the cell radius includes performing a time advance measurement.

8. The method of claim 1, wherein the operation of distributing the plurality of users to the plurality of layers includes assigning a first user having a high payload to a first layer of the plurality of layers and assigning a second user having a low payload to a second layer of the plurality of layers, wherein the first layer has a wider bandwidth than the second layer.

9. The method of claim 1, further comprising:
repeating the operations of receiving the traffic data, determining the cell radius, and distributing the plurality of users at a predetermined interval.

10. A telecommunications network comprising:
a wireless access point configured to provide network services in a plurality of layers, respective ones of the plurality of layers having different bandwidth characteristics; and
a virtual radio access network (RAN) server operatively connected to the wireless access point, the virtual RAN server configured to:
receive a traffic data for the wireless access point,
determine a cell radius for respective ones of the plurality of layers, and
in response to a determination that the plurality of layers are coincident, distribute a plurality of users to the plurality of layers based on the traffic data.

11. The telecommunications network of claim 10, wherein the traffic data includes a payload-per-user data.

12. The telecommunications network of claim 10, wherein the virtual RAN server includes a RAN Intelligence Controller (RIC).

13. A non-transitory computer-readable medium storing instructions that, when executed by at least one processor of a computer in a telecommunications network configured to provide network services in a plurality of layers respectively having different bandwidth characteristics, cause the computer to perform operations comprising:
receiving a traffic data for a cell site of the telecommunications network;
determining a cell radius for respective ones of the plurality of layers; and
in response to a determination that the plurality of layers are coincident, distributing a plurality of users to the plurality of layers based on the traffic data.

14. The non-transitory computer-readable medium of claim 13, wherein the computer includes a Radio Access Network Intelligence Controller (RIC).

15. The non-transitory computer-readable medium of claim 14, wherein the RIC includes a Near Real-Time RIC configured to perform the operations of receiving the traffic data, determining the cell radius, and distributing the plurality of users to the plurality of layers.

16. The non-transitory computer-readable medium of claim 14, wherein the operation of distributing the plurality of users to the plurality of layers includes:
establishing a plurality of categories based on payload traffic thresholds;
assigning the plurality of users to the plurality of categories based on a comparison of the traffic data to the payload traffic thresholds; and
assigning subsets of the plurality of users in each of the plurality of categories to corresponding ones of the plurality of layers.

17. The non-transitory computer-readable medium of claim 16,
wherein the RIC includes a Non-Real-Time RIC,
wherein the instructions, when executed by the at least one processor, cause the Non-Real-Time RIC to the operation of establishing the plurality of categories, and
wherein the operation of establishing the plurality of categories includes:
generating at least one policy based on the traffic data; and
setting the payload traffic thresholds based on the at least one policy.

18. The non-transitory computer-readable medium of claim 13, wherein the operation of determining the cell radius includes performing a time advance measurement.

19. The non-transitory computer-readable medium of claim 13, wherein the operation of distributing the plurality of users to the plurality of layers includes assigning a first user having a high payload to a first layer of the plurality of layers and assigning a second user having a low payload to a second layer of the plurality of layers, wherein the first layer has a wider bandwidth than the second layer.

20. The non-transitory computer-readable medium of claim 13, the operations further comprising:
repeating the operations of receiving the traffic data, determining the cell radius, and distributing the plurality of users at a predetermined interval.
